(19) United States
(12) Patent Application Publication
(10) Pub. No.: US 2022/0383183 A1
(43) Pub. Date: Dec. 1, 2022

(54) MACHINE LEARNING PIPELINE OPTIMIZATION

(71) Applicant: International Business Machines Corporation, Armonk, NY (US)

(72) Inventors: Lei Gao, XIAN (CN); Jin Wang, Xi'an (CN); Kai Li, XIAN (CN); Jing James Xu, Xi'an (CN); A PENG ZHANG, XIAN (CN)

(21) Appl. No.: 17/332,622

(22) Filed: May 27, 2021

(51) Int. Cl. G06N 20/00

(52) U.S. Cl. CPC G06N 20/00

(57) ABSTRACT

A processor may identify a first plurality of transformation nodes from a machine learning pipeline. The processor may couple the first plurality of transformation nodes in series to obtain a sequence of transformation nodes. The processor may select a first transformation node and a second transformation node from the sequence of transformation nodes based on at least one of an input data size and output data size of each of the first plurality of transformation nodes, the second transformation node being subsequent and adjacent to the first transformation node in the sequence of transformation nodes. The processor may obtain an optimized machine learning pipeline by coupling a second plurality of transformation nodes from the machine learning pipeline between the first transformation node and the second transformation node in the sequence of transformation nodes.

### BACKGROUND

The present disclosure relates to a computing system, and more specifically, to optimizing a machine learning pipeline by the computing system.

A machine learning (ML) pipeline is a way to codify and automate the machine learning workflow it takes to produce a machine learning model. Machine learning pipelines include multiple sequential steps that do almost everything from data ingestion and preprocessing to model training and deployment. Machine learning pipelines are popularly adopted to solve a complex modeling problem by forming a pipeline with a series of algorithm nodes. For example, a machine learning workflow may include a number of algorithm nodes (for example, data transformation nodes and data modeling nodes) where the data transformation nodes may account for a large proportion of the algorithm nodes. In many situations, the machine learning workflow may be very complex in order to solve a complicated modeling problem. Accordingly, the machine learning workflow may be optimized such that the optimized workflow utilizes less computing resources.

### SUMMARY

Embodiments of the present disclosure include a method, computer program product, and system for optimizing a machine learning pipeline by a computing system.

In some embodiments, a processor may identify a first plurality of transformation nodes from a machine learning pipeline. The processor may couple the first plurality of transformation nodes in series to obtain a sequence of transformation nodes. The processor may, in response to determining that an output data size of a first transformation node of the first plurality of transformation nodes is below a predefined threshold or an input data size of a second transformation node of the first plurality of transformation nodes is below a predefined threshold, select the first transformation node and the second transformation node from the sequence of transformation nodes, the second transformation node being subsequent and adjacent to the first transformation node in the sequence of transformation nodes. The processor may obtain an optimized machine learning pipeline by coupling a second plurality of transformation nodes from the machine learning pipeline between the first transformation node and the second transformation node in the sequence of transformation nodes.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 shows a cloud computing node according to some aspects of the present disclosure.

FIG. 2 shows a cloud computing environment according to some aspects of the present disclosure.

FIG. 3 shows abstraction model layers according to some aspects of the present disclosure.

FIG. 4 shows a block diagram illustrating a machine learning (ML) pipeline optimization system according to some aspects of the present disclosure.

FIG. 5 shows a schematic diagram illustrating an example of an ML pipeline according to some aspects of the present disclosure.

FIG. 6 shows an example of the input data received from the data source according to some aspects of the present disclosure.

FIG. 7 shows an example table illustrating record operations identified from the ML pipeline according to some aspects of the present disclosure.

FIG. 8 shows an example table illustrating field operations identified from the ML pipeline according to some aspects of the present disclosure.

FIG. 9 shows an example method for record operation analysis according to some aspects of the present disclosure.

FIG. 10 shows an example table illustrating the input data size and output data size of each record operation node according to some aspects of the present disclosure.

FIG. 11 shows a pipeline of field operation nodes according to some aspects of the present disclosure.

FIG. 12 shows an example table illustrating the input field and output field of each field operation node according to some aspects of the present disclosure.

FIG. 13 shows an example graph illustrating the topology of the input and output fields according to some aspects of the present disclosure.

FIG. 14 shows an example graph illustrating the topology of the field operation nodes according to some aspects of the present disclosure.

FIG. 15 shows a schematic diagram illustrating how to insert the field operation nodes into the pipeline of record operation nodes according to some aspects of the present disclosure.

FIG. 16 shows an optimized ML pipeline in response to inserting the field operation nodes into the record operation pipeline according to some aspects of the present disclosure.

FIG. 17 shows an optimized ML pipeline in response to relocating a field operation node according to some aspects of the present disclosure.

FIG. 18 shows a schematic diagram illustrating a method for calculating the execution time of an ML pipeline according to some aspects of the present disclosure.

FIG. 19 shows a flowchart illustrating a method for optimizing an ML pipeline according to some aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

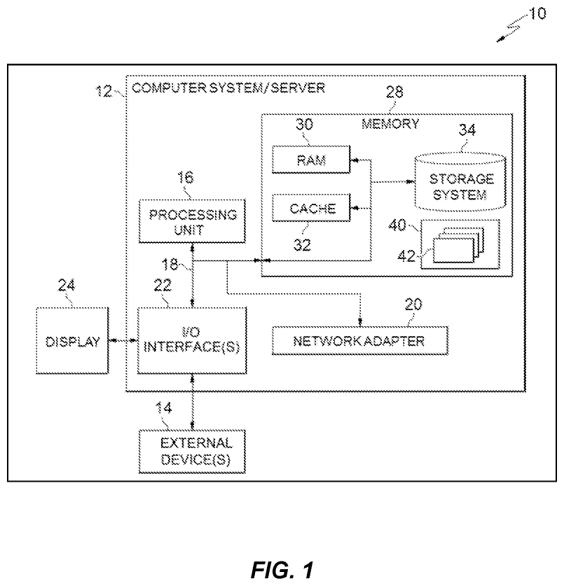

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 may include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 (by way of example and not limitation), as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

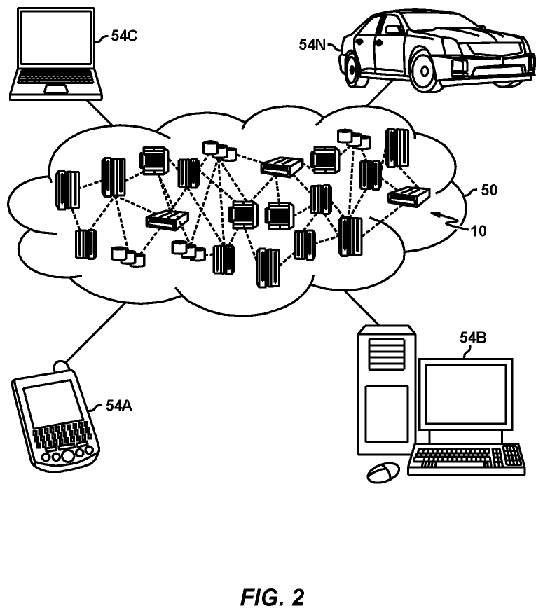

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

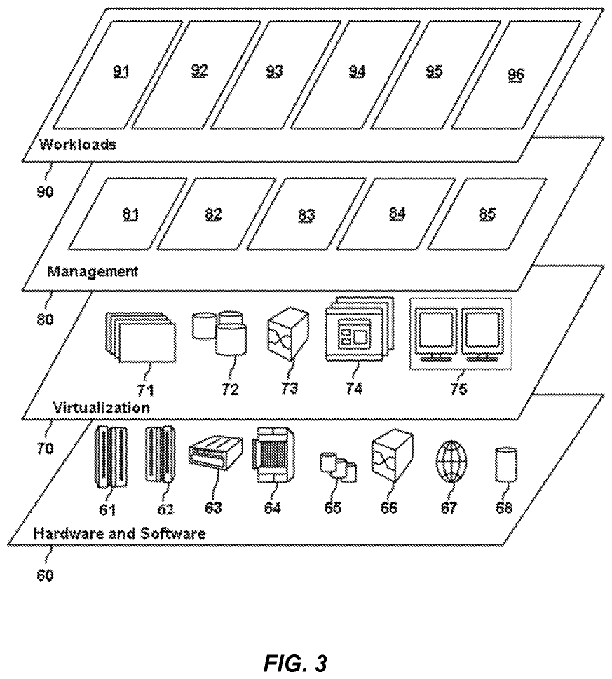

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning (ML) pipeline optimizing 96.

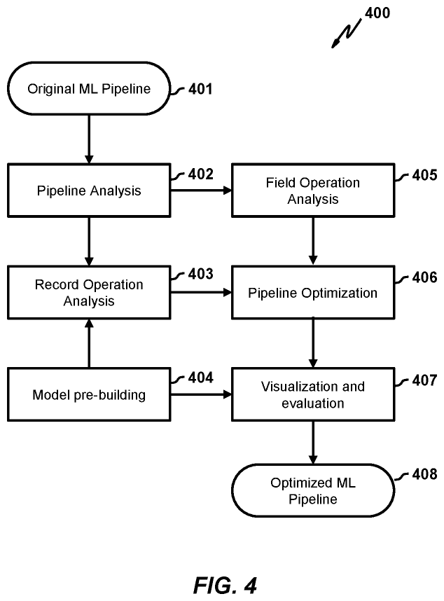

With reference now to FIG. 4, a block diagram of an example ML pipeline optimization system 400 is shown. The ML pipeline optimization system 400 is only one example of the ML pipeline optimizing 96 and is not intended to suggest any limitation as to the scope of use or functionality of embodiments of the disclosure described herein.

The ML pipeline optimization system 400 may obtain an ML pipeline 401 (defined by a user, for example) and is configured to optimize the ML pipeline 401. The ML pipeline 401 may be a branch of an ML workflow and includes a number of transformation nodes coupled in series or in sequence. For example, each of the transformation nodes may be configured to transform the input data to this transformation node into the output data to be provided to a subsequent transformation node. The transformation nodes may include algorithm nodes, data transformation nodes, data modeling nodes, and the like. As an example, at least one branch of the ML workflow may be optimized by the ML pipeline optimization system 400. As another example, all the branches of the ML workflow may be optimized by the ML pipeline optimization system 400. It is noted that the transformation node may also be referred to as node herein without obstructing the present disclosure.

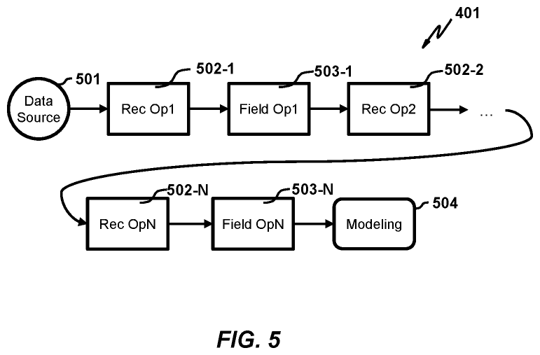

FIG. 5 shows an example of the ML pipeline 401 according to some embodiments of the present disclosure. It is to be understood that the ML pipeline 401 is provided for illustrative purpose only without suggesting any limitation as to the scope of the present disclosure. The ML pipeline 401 includes a data source node 501 configured to provide a collection of input data to the subsequent transformation nodes of the ML pipeline 401 for further processing. For example, the input data provided by the data source 501 may be formatted in two orthogonal dimensions. As an example, one of the orthogonal dimensions is a field dimension and the other of the orthogonal dimensions is a record dimension.

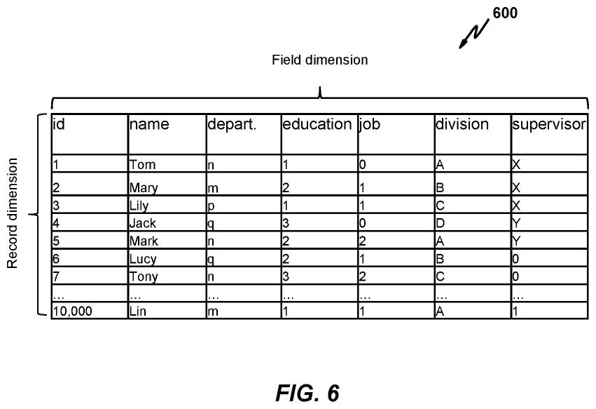

FIG. 6 shows an example of the input data 600 from the data source 501 according to some embodiments of the present disclosure. It is to be understood that the input data 600 is provided for illustrative purpose only without suggesting any limitation as to the scope of the present disclosure. As shown in FIG. 6, the input data 600 is formatted as a matrix. The input data 600 includes a number (e.g., 10,000) of records, where each record corresponds to a row of the matrix. The input data 600 further includes multiple fields with each field corresponding to a column of the matrix, for example, name, department, education, job, division, and supervisor. In this example, the field dimension of the input data 600 corresponds to the columns of the matrix and the record dimension of the input data 600 corresponds to the rows of the matrix. In another example, the field dimension of the input data 600 may correspond to the rows of the matrix and the record dimension of the input data 600 may correspond to the columns of the matrix.

Referring back to FIG. 5, the ML pipeline 401 may further include a number of transformation nodes coupled in series subsequent to the data source node 501. In some embodiments, the transformation nodes in the ML pipeline 401 may be classified into field operation nodes and record operation nodes, depending on the orthogonal dimensions of the input data, for example, the input data 600. In the ML pipeline 401, the record operation nodes may include the 1st record operation node 502-1, the second record operation node 502-2 . . . and the N-th record operation node 502-N, which may be collectively referred to as record operation nodes 502. The field operation nodes may include the 1st field operation node 503-1 . . . and the N-th field operation node 503-N, which may be collectively referred to as field operation nodes 503. The number of the transformation nodes in the ML pipeline 401 is provided for illustrative purpose only and the ML pipeline 401 can include any other suitable number of transformation nodes including any suitable number of field operation nodes and any suitable number of record operation nodes. The number of the field operation nodes may be the same or different from the number of the record operation nodes in the ML pipeline 401.

Each of the transformation nodes is configured to transform the input data for this transformation node into the output data. For example, each transformation node may include a data input configured to receive the input data provided by an upstream node in the ML pipeline 401 and a data output configured to provide the output data to a downstream node in the ML pipeline 401. As shown in FIG. 5, the record operation node 502-1 may receive the input data from the data source 501 and process the received input data to obtain output data. The record operation node 502-1 may then provide the output data to the field operation node 503-1. The field operation node 503-1 may receive the input data from the record operation node 502-1 and process the input data to obtain output data. The field operation node 503-1 may then provide the output data to the record operation node 502-2, and so on.

In some embodiment, the transformation nodes in the ML pipeline 401 may be configured to perform various operations on their respective input data. For example, the operations may be record operations configured to operate on the records or rows of the input data. The record operations may involve adding one or more records to the input data or deleting one or more records or rows from the input data. As a result, the record operation nodes may have a substantial impact on the data throughput. For example, the record operations may include selecting, sampling, and so on. The select node, for example, may be configured to select one or more specified records from the input data, and the output data size of the selection node may be less than the input data size of the selection node. The sample node may be configured to sample a number of records from the input data, and the output data size of the sample node may be less than the input size of the sample node. For example, as shown in FIG. 6, a number of 100 records may be sampled out of the 10,000 records in the sample node, and the output data size is 1/100 of the input data size of the sample node.

In addition, the operations may be field operations configured to operate on the field or columns of the input data. The field operation nodes, on the other hand, may involve adding one or more fields to the input data or deleting one or more fields from the input data. For example, the field operations may include deriving, binning, filtering, and so on. The derive node may be configured to calculate or otherwise derive one or more fields from the existing fields and add the derived fields to the input data. The bin node may be configured to replace the values of one or more fields in the input data which fall into a given small interval, a bin, by a value representative of that interval, for example, the central value. The filter node may be configured to select one or more fields from the input data to obtain the output data. For example, as shown in FIG. 6, a new field may be generated from the fields “department” and “job” by a condition check. The condition may be (department==m) and (job==1), for example. If the condition is met, the value of the new field is set as “T”; if the condition is not met, the value of the new field value is set as “F”.

The ML pipeline 401 may further include a modeling node 504, as shown in FIG. 5. The modeling node 504 may model the data processed by the previous nodes in the ML pipeline 401. For example, the modeling node 504 may be configured to train an ML model based on the data processed by the previous nodes in the ML pipeline 401. The transformation nodes in the ML pipelines 401 may be configured to transform and correlate the input data from the data source 501 to the ML model trained by the modeling node 504.

Referring back to FIG. 4, at block 402, a pipeline analysis may be performed on the ML pipeline 401. In some embodiments, the pipeline analysis may include identifying the types or classes of the transformation nodes in the ML pipeline 401, for example, whether the transformation nodes are record operation nodes or field operation nodes. In some embodiments, the output data of a transformation node may be compared to the input data of the transformation node to determine whether the transformation node is a record operation node or a field operation node. If, for example, the record number of the output data is greater or less than the record number of the input data of the transformation node, the transformation node may be identified as a record operation node. On the other hand, if the field number of the output data is greater or less than the field number of the input data of the transformation node, the transformation node may be identified as a field operation node.

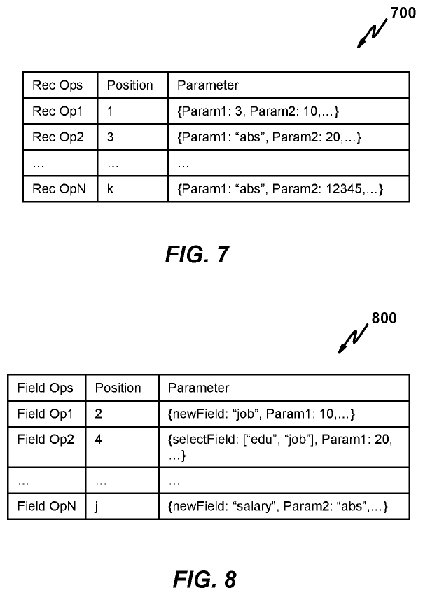

FIG. 7 shows an example table 700 illustrating record operations identified from the ML pipeline 401 according to some embodiments of the present disclosure. As shown in FIG. 7, the 1st, 3rd . . . and k-th nodes in the ML pipeline 401 are identified as record operation nodes and may be referred to as 1st, 2nd . . . and N-th record operation nodes. FIG. 8 shows an example table 800 illustrating field operations identified from the ML pipeline 401 according to some embodiments of the present disclosure. As shown in FIG. 8, the 2nd, 4th, and jth nodes in the ML pipeline 401 are identified as field operation nodes and may be referred to as 1st, 2nd . . . and N-th field operation nodes. It is noted that the tables in FIGS. 7 and 8 are provided for illustrative purpose only without suggesting any limitations as to the scope of the present disclosure.

In some embodiments, the pipeline analysis may further include extracting or retrieving the parameters of the transformation nodes in the ML pipeline 401. As shown in FIG. 7, the parameters of the 1st record operation node Rec Op1 are {Param1: 3, Param2: 10, . . . }, which means that the first parameter has a value of 3, the second parameter has a value of 10, and so on. The parameters of the 2nd record operation node Rec Op2 are {Param1: “abs”, Param2: 20, . . . }, which means that the first parameter has a value of “abs”, and the second parameter has a value of 20. The parameters of the N-th record operation node Rec OpN are {Param1: “abs”, Param2: 12345, . . . }, which means that the first parameter has a value of “abs”, and the second parameter has a value of 12345.

Additionally, as shown in FIG. 8, the parameters of the 1st field operation node Field Op1 are {newField: “job”, Param1: 10, . . . }, which means that the first field operation is to add a new field named “job” and the first parameter has a value 10. The parameters of the 2nd field operation node Field OP2 are {selectField: [“edu”, “job”], Param1: 20, . . . }, which means that the second field operation is to select the fields named “edu” and “job” as the output and the first parameter has a value of 20. The parameters of the N-th field operation node Field OP2 are {newField: “salary”, Param2: “abs”, . . . }, which means that the N-th field operation is to create a new field named “salary” and the second parameter has a value of “abs”. The extracted parameters of the transformation nodes may be provided for subsequent processing.

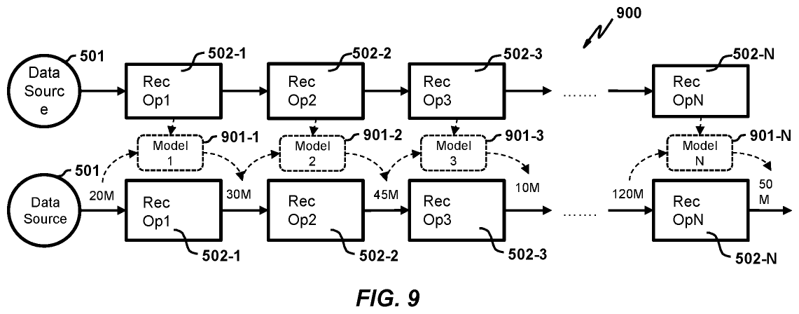

Referring back to FIG. 4, at block 403, record operation analysis may be performed on the record operation nodes identified at block 402. For example, the record operation nodes 502 in the ML pipeline 401 may be coupled in series or in sequence based on the sequence of the record operation nodes in the ML pipeline 401. FIG. 9 shows an example method 900 for record operation analysis according to some embodiments of the present disclosure. For example, the 1st to N-th record operation nodes 502 in the table 700 may be coupled in series or in sequence to obtain a sequence of transformation nodes, as shown in FIG. 9. The record operation nodes 502 are coupled in series or in sequence and the 1st record operation node 502-1 is further coupled to the data source 501.

In addition, the record operation analysis may further include determining the input data size and output data size of each record operation node 502. As shown in FIG. 9, the 1st model 901-1 may obtain the input data size and parameters of the 1st record operation node 502-1. In this example, the input data size of the 1st record operation node 502-1 is 20 MB, which may be determined from the data size of the data source 501. The parameters of the 1st record operation node 502-1 may be stored as the 1st row in the table 700, which may be retrieved and provided to the 1st model 901-1. The 1st model 901-1 may determine the output data size of the 1st record operation node 502-1 based on the input data size and the parameters of the 1st record operation node 502-1. In this example, the output data size of the 1st record operation node 502-1 may be determined to be 30 MB, as show in FIG. 9.

The 2nd model 901-2 may obtain the input data size and parameters of the 2nd record operation node 502-2. In this example, the input data size of the 2nd record operation node 502-2 is the same as the output data size of the 1st record operation node 502-1, i.e., 30 MB. The parameters of the 2nd record operation node 502-2 may be stored as the 2nd row in the table 700, which may be retrieved and provided to the 2nd model 901-2. The 2nd model 901-2 may determine the output data size of the 2nd record operation node 502-2 based on the input data size and the parameters of the 2nd record operation node 502-2. In this example, the output data size of the 2nd record operation node 502-2 may be determined to be 45 MB, as show in FIG. 9.

The 3rd model 901-3 may obtain the input data size and parameters of the 3rd record operation node 502-3. In this example, the input data size of the 3rd record operation node 502-3 is the same as the output data size of the 2nd record operation node 502-2, i.e., 45 MB. The parameters of the 3rd record operation node 502-3 may be stored as the 3rd row (not shown) in the table 700, which may be retrieved and provided to the 3rd model 901-3. The 3rd model 901-3 may determine the output data size of the 3rd record operation node 502-3 based on the input data size and the parameters of the 3rd record operation node 502-3. In this example, the output data size of the 3rd record operation node 502-3 may be determined to be 10 MB, as show in FIG. 9.

The N-th model 901-N may obtain the input data size and parameters of the N-th record operation node 502-N. In this example, the input data size of the N-th record operation node 502-N is the same as the output data size of the N−1-th record operation node 502-N−1, i.e., 120 MB. The parameters of the N-th record operation node 502-N may be stored as the N-th row in the table 700, which may be retrieved and provided to the N-th model 901-N. The N-th model 901-N may determine the output data size of the N-th record operation node 502-N based on the input data size and the parameters of the N-th record operation node 502-N. In this example, the output data size of the N-th record operation node 502-N may be determined to be 50 MB, as show in FIG. 9.

The 1st models 901-1, the 2nd model 901-2, and the N-th model 901-N may be collectively referred to as model(s) 901. It is to be understood that the models 901 may be the same or different from each other. Each model 901 is configured to obtain the input data size and the parameters of the corresponding record operation node 502 and determine the output data size of the record operation node 502 based on the input data size and the parameters of the record operation node 502. As a result, the input data size and output data size of each record operation node 502 may be determined.

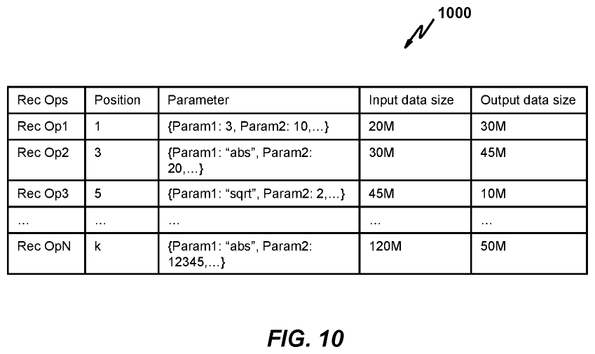

In some embodiments, the input data size and output data size of each record operation node may be saved in a table. FIG. 10 shows an example table 1000 illustrating the input data size and output data size of each record operation node in the example as shown in FIGS. 7 and 9. The table 1000 includes two additional columns concatenated to the table 700, i.e., a column of input data size and a column of output data size.

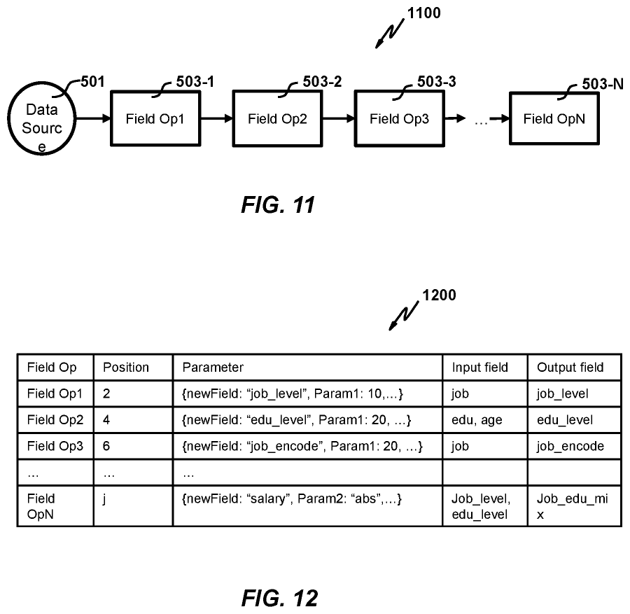

Referring back to FIG. 4, at block 405, field operation analysis may be performed on the field operation nodes 503 identified at block 402. For example, the field operation nodes 503 in the ML pipeline 401 may be coupled in series or in sequence to form a pipeline of field operation nodes. FIG. 11 shows a pipeline 1100 of field operation node according to some embodiments of the present disclosure. The pipeline 1100 includes the field operation nodes 503 coupled in series to the data source 501. The field operation analysis may include determining the input field(s) and output field(s) of each field operation node 503. In some embodiments, the input fields and output fields of a field operation node 503 may be determined from the parameters of the field operation node 503. For example, the field operation node 503 may be to derive a new field based on one or more of the fields of the input data and to add the new field into the input data, thereby obtaining the output data. In this instance, the input fields may be the one or more fields operated by the derive operation and the output field may be the new field created by the derive operation.

In some embodiments, the input fields and output fields of each field operation node 503 may be saved to a table. FIG. 12 shows an example table 1200 illustrating the input field and output field of each field operation node in the example as shown in FIGS. 8 and 11. In this example, the names of the input fields and output fields may be concatenated to the table 800 in FIG. 8 to obtain the table 1200.

In some embodiments, the topology of the field operation nodes 503 may be determined based on the input and output fields of the field operation nodes 503. The topology of the field operation nodes 503 may be represented by a graph including a plurality of nodes connected to each other, where each node in the graph may represent a field operation node 503 in the ML pipeline 401. In some embodiments, the graph representing the topology of the field operation nodes 503 may be a Directed Acyclic Graph (DAG), which may be generated by traversing the field operation nodes 503 from node to node. For example, the DAG may be generated by traversing the table 1200 of FIG. 12 from row to row to represent the topology of the field operation nodes 503.

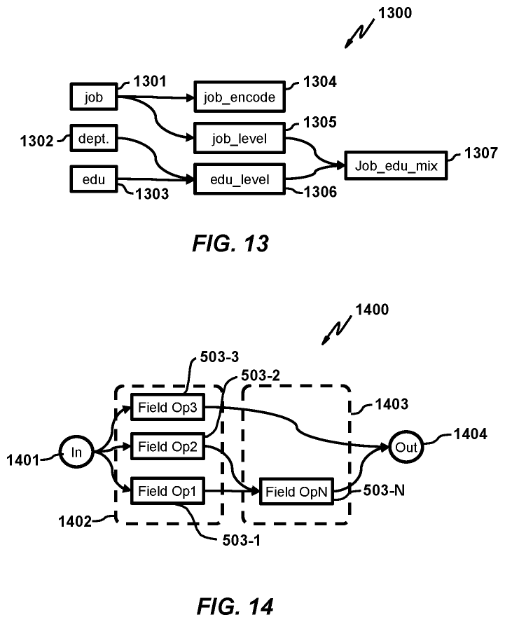

FIG. 13 shows an example graph 1300 illustrating the topology of the input and output fields according to some embodiments of the present disclosure. For example, the graph 1300 may be generated from the table 1200. The first row of the table 1200 shows that the input field of the 1st field operation is “job” and the output field of the 1st field operation is “job_level”. As a result, the “job” field node 1301 is coupled to the “job-level” field node 1305 and the “job” field node 1301 points to the “job-level” field node 1305, as shown in FIG. 13. The second row of the table 1200 shows that the input fields of the 2nd field operation is “edu” and “department” and the output field of the 2nd field operation is “edu_level”. As a result, the “edu” and “department” field nodes 1302 and 1303 are coupled to the “edu_level” field node 1306, and the “edu” and “department” field nodes 1302 and 1303 point to the “edu_level” field node 1306. The third row of the table 1200 shows that the input field of the 3rd field operation is “job” and the output field of the 3rd field operation is “job_encode”. As a result, the “job” field node 1301 is further coupled to the “job_encode” field node 1304 and the “job” field node 1301 points to the “job_encode” field node 1304. The N-th row of the table 1200 shows that the input fields of the N-th field operation are “job_level” and “edu_level” and the output field of the N-th field operation is “job_edu_mix”. As a result, the “job_level” and “edu_level” field nodes 1305 and 1306 are coupled to the “job_edu_mix” field node 1307, and the “job_level” and “edu_level” field nodes 1305 and 1306 point to the “job_edu_mix” field node 1307. In this way, the graph 1300 can be generated from the table 1200.

FIG. 14 shows an example graph 1400 illustrating the topology of the field operation nodes 503 according to some embodiments of the present disclosure. The graph 1400 of FIG. 14 may be generated from the graph 1300 of FIG. 13. For example, the “job” field node 1301, “department” field node 1302, and “edu” field node 1303 may be converted into an input node 1401. The arrow from the “job” field node 1301 to the “job_encode” field node 1304 may be converted to the 3rd field operation node 503-3. The arrow from the “job” field node 1301 to the “job_level” field node 1305 may be converted to the 2nd field operation node 503-2. The arrows from the “age” field node 1302 and the “edu” field node 1303 to the “edu_level” field node 1306 may be converted to the 1st field operation node 503-1. The arrows from the “job_level” field node 1305 and the “edu_level” field node 1306 to the “job_edu_mix” field node 1307 may be converted to the N-th field operation node 503-N. The “job_encode” field node 1304 and the “job_edu_mix” field node 1307 may be converted to an output node 1404. As a result, the graph 1400 is generated from the graph 1300 of FIG. 13 to represent the field operations in the ML pipeline 401.

Alternatively, the graph 1400 may be generated from the table 1200 of FIG. 12. For example, the output field of the 1st field operation node 503-1 is the “job_level” field and the input of the N-th field operation node 503-N is also the “job_level” field. As a result, the output of the 1st field operation node 503-1 may be coupled to the input of the N-th field operation node 503-N. As a result, the graph 1400 can be generated from the table 1200 by traversing the field operation nodes.

The field operation nodes may be parallelized based on the topology of FIG. 14. In this example, the field operation nodes 503-1, 503-2, and 503-3 may be executed in parallel. For example, the field operation nodes 503-1, 503-2, and 503-3 may be abstracted into a field operation node 1402 and may be executed together in a first step. The field operation node 503-N may be executed in a second step subsequent to the first step. As a result, the four field operations, which are executed in four steps in the original flow, can be executed in two steps in the optimized flow. The optimized field operation graph can enable independent algorithms to be parallelized as much as possible, such the execution time of the system may be substantially decreased.

Referring back to FIG. 4, at block 406, a pipeline optimization may be performed based on the record operation analysis at block 403 and the field operation analysis at block 405. For example, the optimized field operations flow may be inserted between two adjacent record operations where the data size therebetween is the minimum.

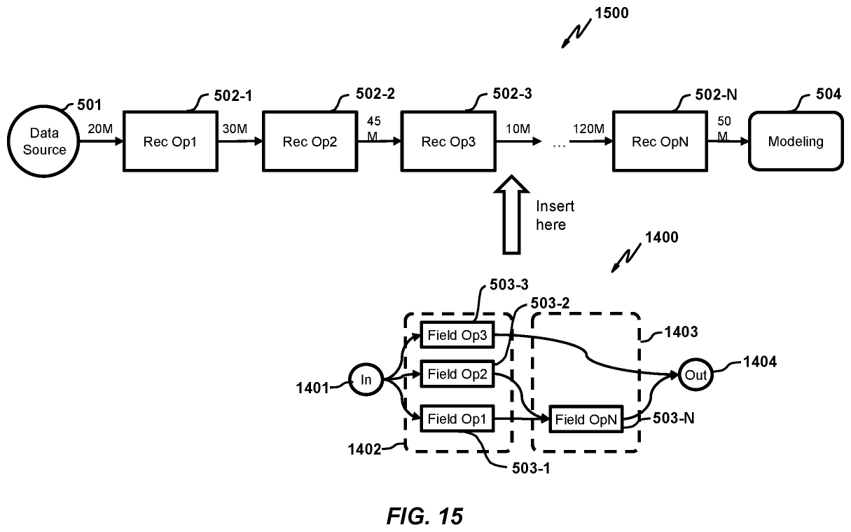

FIG. 15 shows a schematic diagram 1500 illustrating how to insert the field operation nodes into the record operation nodes according to some embodiments of the present disclosure. As shown in FIGS. 9 and 15, the output data size of the record operation node 502-3 is 10 MB, which is the minimum output data size of all the record operation nodes 502. The graph 1400 of field operation may be inserted into this location such that the output data of the record operation node 502-3 is coupled to the input node 1401 of the graph 1400 of field operation and the output node 1404 of the graph 1400 of field operation is coupled to a record operation node (not shown) subsequent to the record operation node 502-3.

Alternatively, it may be determined whether the input data size of a transformation node is below a predefined threshold. If it is determined that the input data size of the transformation node is below the predefined threshold, the transformation node and the previous adjacent transformation node may be selected to allow the field operation nodes (such as the graph 1400 of field operation) to be inserted between the transformation nodes. Alternatively, it may be determined whether the output data size of a transformation node is below a predefined threshold. If it is determined that the output data size of the transformation node is below the predefined threshold, the transformation node and the next adjacent transformation node may be selected to allow the field operation nodes such as the graph 1400 of field operation to be inserted between the transformation nodes.

By checking the data throughput between the record operation nodes and inserting the field operation nodes between adjacent record operation nodes with minimum data throughput, the field operation nodes can be configured to operate on the minimum amount of data, such that the computing system may have a reduced workload and the execution time of the computing system may also be substantially decreased.

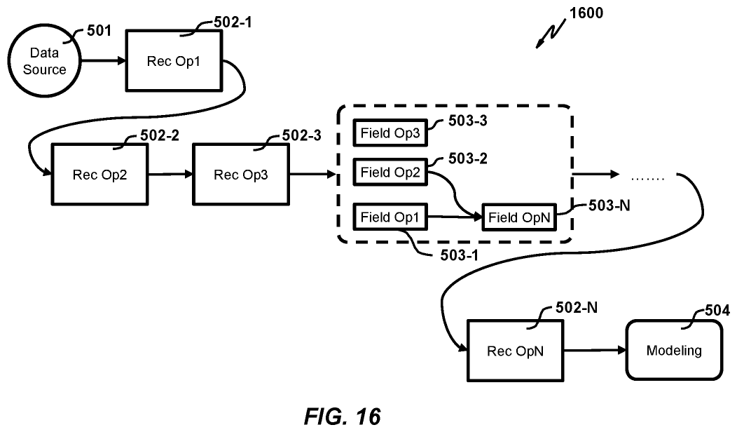

FIG. 16 shows an optimized ML pipeline 1600 in response to inserting the field operation nodes into the record operation pipeline. In some embodiments, an upstream record operation node may depend on the output field of a downstream field operation node. For example, the parameters of the 2nd record operation node 502-2 may be {Param1: 3, Param2: 10, Param3: “job_encode” . . . } and the parameters of the 3rd field operation node 503-3 may be {new field: “job_encode”}. The 2nd record operation node 502-2 depends on the field “job_encode” generated by the 3rd field operation node 503-3 but the 3rd field operation node 503-3 is inserted subsequent to the 2nd record operation node 502-2, as shown in FIG. 16. In this instance, the 3rd field operation node 503-3 may be relocated prior to the 2nd record operation node 502-2.

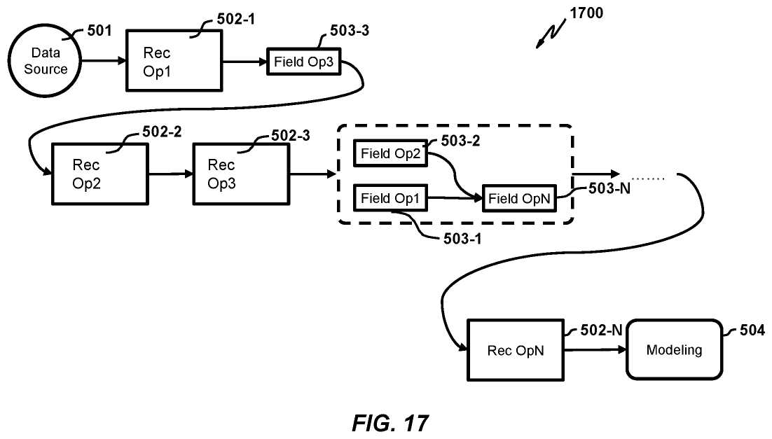

FIG. 17 shows an optimized ML pipeline 1700 in response to relocating the 3rd field operation node 503-3 in the ML pipeline 1600. As shown in FIG. 17, the 2nd record operation node 502-2 depends on the field “job_encode”, which is generated by its upstream node, i.e., the relocated 3rd field operation node 503-3.

Referring back to FIG. 4, at block 407, visualization and/or evaluation may be performed on the optimized ML pipeline. For example, the optimized ML pipeline 408 may be visualized and presented to the user. For example, the visualized pipeline may include the transformation nodes where each transformation node is correlated to the corresponding parameters. In response to the user selecting the transformation node, the parameters of the transformation node may be presented to the user. Additionally or alternatively, the optimized ML pipeline 408 may be executed before presenting to the user. In this way, the optimized ML pipeline 408 may be determined to be operational before presenting to the user.

In addition or alternatively, the performance of the original ML pipeline 401 and the optimized ML pipeline 408 may be compared to evaluate the optimized ML pipeline 408. For example, the execution time of the ML pipeline 401 and 408 may be calculated and the improvement of the execution time may be determined.

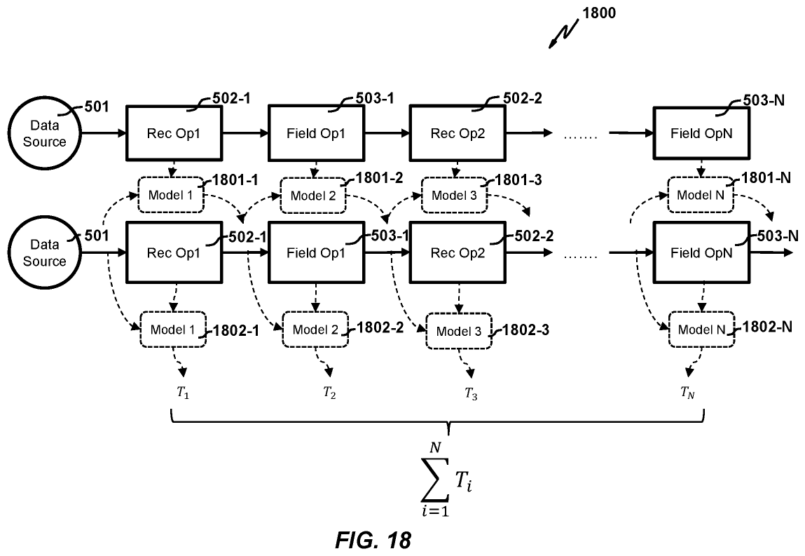

FIG. 18 shows a schematic diagram illustrating a method 1800 for calculating the execution time of an ML pipeline according to some embodiments of the present disclosure. The method 1800 may be applied to the original ML pipeline 401 and may also be applied to the optimized ML pipeline 408, for example, the ML pipeline 1700.

The models 1801-1, 1801-2, 1801-3 . . . , and 1801-N (collectively referred to as 1801) may be similar to the models 901 as shown in FIG. 9 and may be configured to obtain the input data size and parameters of respective transformation nodes and determine an output data size of the transformation nodes based on the input data size and the parameters of the transformation nodes. For example, the model 1801-1 may obtain the input data size of the record operation node 502-1 and the parameters of the record operation node 502-1. The model 1801-1 may determine the output data size of the record operation node 502-1 based on the input data size and the parameters of the record operation node 502-1. In this way, the input data size and output data size of each transformation node 502 or 503 can be determined.

The models 1802-1, 1802-2, 1802-3 . . . , and 1802-N (collectively referred to as 1802) are configured to obtain the input data size and the parameters of respective transformation nodes. The input data size of each transformation node may be determined by the models 1801. The models 1802 may then determine an execution time of each transformation node based on the input data size and the parameters of the transformation node. For example, the model 1802-1 may obtain the input data size and the parameters of the transformation node 502-1. The model 1802-1 may then calculate the execution time Ti of the transformation node 502-1 based on the input data size and the parameters of the transformation node 502-1. In this way, the execution time of each transformation node can be calculated. The total execution time can be calculated by summing the execution time of each transformation node, i.e., Σᵢ₌₀^{N} Ti. It is to be understood that the models 1802-1, 1802-2, 1802-3 . . . , and 1802-N may be the same or different from each other and may be implemented by one or more models. By calculating the total execution time of the original ML pipeline 401 and the optimized ML pipeline 408, the total execution time of the original ML pipeline 401 and the optimized ML pipeline 408 may be compared to determine the improvement in execution time.

In some embodiments, in response to executing the optimized ML pipeline 408, the input data size and output data size for each transformation node in the optimized ML pipeline 408 may be determined, which may be more accurate than the prediction of the models 1801. In this instance, the models 1802 may be applied to the optimized ML pipeline 408 to calculate the total execution time based on the input data size and/or output data size. In addition, in response to updating the input data size and output data size, it is possible for the location for the minimum data size to be different from the one determined by the method 900. In this case, the pipeline optimization 406 may be repeated based on the updated input data size and output data size to achieve an even better result.

Referring back to FIG. 4, at block 404, the models 901, 1801, and 1802 may be pre-built before the optimization process. The models 901 and 1801 are configured to predict the output data size for record operation and field operation nodes, and the models 1802 are configured to predict the node execution time for both record operation and field operation nodes. To this end, a first model may be pre-built to predict the output data size for record operation and field operation nodes and a second model may be pre-built to predict the node execution time for both record operation and field operation nodes. For example, the first and second models may be regression models.

During the software life cycle, a great amount of testing data may be produced in the node functionality testing phase, including input data size, output data size, node execution time, node parameters, and the like. The data may be collected to build the first and second models. For example, when building the first model, the predictors may include the input data size, for example, the record count and field count (column count), node parameters, and the like. The target of the first model may be the output data size. In this way, the first model may be built against the collected testing data. When building the second model, on the other hand, the predictors may include the input data size, for example, the record count and field count (column count), node parameters, and the like. The target of the second model may be the node execution time. In this way, the second model may be built against the collected testing data. Upon building the first and second models, they may be delivered together with the nodes to provide the prediction of the output data size and execution time for each node in real-time customer ML flow running.

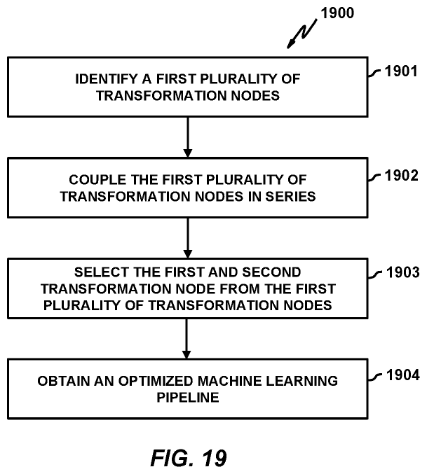

FIG. 19 shows a method 1900 for optimizing an ML pipeline according to some embodiments of the present disclosure. The method 1900 can be implemented by the ML pipeline optimization system 400 as shown in FIG. 4 or ML optimizing 96 as shown in FIG. 3. It is to be understood that the method 1900 can be implemented by any other suitable system.

At block 1901, the method 1900 includes identifying a first plurality of transformation nodes from a machine learning pipeline. In some embodiments, each of the first plurality of transformation nodes is configured to perform a record operation on input data to the corresponding transformation node, and each of the second plurality of transformation nodes is configured to perform a field operation on input data to the corresponding transformation node. For example, the machine learning pipeline may be the ML pipeline 401 and the first plurality of transformation nodes may be the record operation nodes 502.

At block 1902, the method 1900 includes coupling the first plurality of transformation nodes in series to obtain a sequence of transformation nodes. For example, the record operation nodes 502 may be coupled in series as shown in FIG. 9.

At block 1903, the method 1900 includes selecting a first transformation node and a second transformation node from the first plurality of transformation nodes based on an input data size and output data size of each of the first plurality of transformation nodes. The second is subsequent and adjacent to the first transformation node in the sequence of transformation nodes.

In some embodiments, the method 1900 further comprises determining the output data size of the transformation node based on the input data size and parameters of the corresponding transformation node. For example, the input data size and output data size may be determined by the method shown in FIG. 9.

In some embodiments, in response to determining that the first transformation node has an output data size below a predefined threshold or the second transformation node has an input data size below the predefined threshold, the processing unit selects the first transformation node and second transformation node from the first plurality of transformation nodes. For example, if the first transformation node has a minimum output data size or the second transformation node has a minimum input data size among the first plurality of transformation nodes, the first transformation node and second transformation node are selected from the first plurality of transformation nodes. For example, the selection may be implemented by the method shown in FIG. 15.

At block 1904, the method 1900 includes obtaining an optimized machine learning pipeline by coupling a second plurality of transformation nodes from the machine learning pipeline between the first transformation node and the second transformation node in the sequence of transformation nodes. For example, the second plurality of transformation nodes may be the field operation nodes 503.

In some embodiments, coupling the second plurality of transformation nodes between the first transformation node and the second transformation node comprises: determining a topology of the second plurality of transformation nodes based on input and output fields of the second plurality of transformation nodes, the topology of the second plurality of transformation nodes comprising an input and an output; coupling the second plurality of transformation nodes based on the topology of the second plurality of transformation nodes; and coupling the input and output of the topology to the first transformation node and second transformation node, respectively. For example, this may be implemented by the method(s) shown in FIGS. 11-15.

In some embodiments, the method 1900 further comprises determining dependencies of the first plurality of transformation nodes on the second plurality of transformation nodes based on input and output fields of the first and second plurality of transformation nodes. In some embodiments, the method 1900 further comprises in response to determining that a third transformation node of the first plurality of transformation nodes depends on a fourth transformation node of the second plurality of transformation nodes subsequent to the third transformation node, moving the fourth transformation node prior to the third transformation node. For example, this may be implemented by the method(s) shown in FIGS. 16-17.

In some embodiments, determining the topology of the second plurality of transformation nodes comprises: determining the topology of the second plurality of transformation nodes based on the dependency of the second plurality of transformation nodes to enable at least a portion of the second plurality of transformation nodes to be executed in parallel. This may be implemented by the method(s) shown in FIGS. 12-14.

In some embodiments, the method 1900 further comprises determining an execution time of each of the first and second plurality of transformation nodes based on the input data size and parameters of the transformation node. In some embodiments, the method 1900 further comprises determining a total execution time of the optimized machine learning pipeline based on the execution time of each of the first and second plurality of transformation nodes. For example, this may be implemented by the method(s) shown in FIG. 18.

It should be noted that the processing of ML pipeline optimization according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
identifying, by a processing unit, a first plurality of transformation nodes from a machine learning pipeline;
coupling, by the processing unit, the first plurality of transformation nodes in series to obtain a sequence of transformation nodes;
in response to determining that an output data size of a first transformation node of the first plurality of transformation nodes is below a predefined threshold or an input data size of a second transformation node of the first plurality of transformation nodes is below a predefined threshold, selecting, by the processing unit, the first transformation node and the second transformation node from the sequence of transformation nodes, the second transformation node being subsequent and adjacent to the first transformation node in the sequence of transformation nodes; and
obtaining, by the processing unit, an optimized machine learning pipeline by coupling a second plurality of transformation nodes from the machine learning pipeline between the first transformation node and the second transformation node in the sequence of transformation nodes.

2. The method of claim 1, wherein each of the first plurality of transformation nodes is a record operation node configured to perform a record operation on input data to the record operation node, and
wherein each of the second plurality of transformation nodes is a field operation node configured to perform a field operation on input data to the field operation node.

3. The method of claim 1, further comprising:
determining, by the processing unit, the output data size of each of the first plurality of transformation nodes based on the input data size and parameters of the corresponding transformation node.

4. The method of claim 1, wherein coupling the second plurality of transformation nodes between the first transformation node and the second transformation node comprises:
determining, by the processing unit, a topology of the second plurality of transformation nodes based on input and output fields of the second plurality of transformation nodes, the topology of the second plurality of transformation nodes comprising an input and an output;
coupling, by the processing unit, the second plurality of transformation nodes to one another based on the topology of the second plurality of transformation nodes; and
coupling, by the processing unit, the input and output of the topology to the first transformation node and second transformation node, respectively.

5. The method of claim 4, wherein obtaining the optimized machine learning pipeline comprises:
determining, by the processing unit, dependencies of the first plurality of transformation nodes on the second plurality of transformation nodes based on input and output fields of the first and second plurality of transformation nodes; and
in response to determining that a third transformation node of the first plurality of transformation nodes depends on a fourth transformation node of the second plurality of transformation nodes subsequent to the third transformation node, moving, by the processing unit, the fourth transformation node prior to the third transformation node.

6. The method of claim 4, whether determining the topology of the second plurality of transformation nodes comprises:
determining, by the processing unit, the topology of the second plurality of transformation nodes based on dependency of the second plurality of transformation nodes to enable at least a portion of the second plurality of transformation nodes to be executed in parallel.

7. The method of claim 1, wherein selecting the first transformation node and second transformation node comprises:
in response to determining that the first transformation node has a minimum output data size or the second transformation node has a minimum input data size among the first plurality of transformation nodes, selecting, by the processing unit, the first transformation node and second transformation node from the first plurality of transformation nodes.

8. The method of claim 1, further comprising:
determining, by the processing unit, an execution time of each of the first and second plurality of transformation nodes based on the input data size and parameters of the transformation node; and
determining, by the processing unit, a total execution time of the optimized machine learning pipeline based on the execution time of each of the first and second plurality of transformation nodes.

9. A system comprising:
a memory; and
a processor in communication with the memory, the processor being configured to perform operations comprising:
identifying a first plurality of transformation nodes from a machine learning pipeline;
coupling the first plurality of transformation nodes in series to obtain a sequence of transformation nodes;
in response to determining that an output data size of a first transformation node of the first plurality of transformation nodes is below a predefined threshold or an input data size of a second transformation node of the first plurality of transformation nodes is below a predefined threshold, selecting the first transformation node and the second transformation node from the sequence of transformation nodes, the second transformation node being subsequent and adjacent to the first transformation node in the sequence of transformation nodes; and
obtaining an optimized machine learning pipeline by coupling a second plurality of transformation nodes from the machine learning pipeline between the first transformation node and the second transformation node in the sequence of transformation nodes.

10. The system of claim 9, wherein each of the first plurality of transformation nodes is a record operation node configured to perform a record operation on input data to the record operation node, and
wherein each of the second plurality of transformation nodes is a field operation node configured to perform a field operation on input data to the field operation node.

11. The system of claim 9, wherein the operations further comprise determining the output data size of each of the first plurality of transformation nodes based on the input data size and parameters of the corresponding transformation node.

12. The system of claim 9, wherein coupling the second plurality of transformation nodes between the first transformation node and the second transformation node comprises:
determining a topology of the second plurality of transformation nodes based on input and output fields of the second plurality of transformation nodes, the topology of the second plurality of transformation nodes comprising an input and an output;
coupling the second plurality of transformation nodes to one another based on the topology of the second plurality of transformation nodes; and
coupling the input and output of the topology to the first transformation node and second transformation node, respectively.

13. The system of claim 12, wherein obtaining the optimized machine learning pipeline comprises:
determining dependencies of the first plurality of transformation nodes on the second plurality of transformation nodes based on input and output fields of the first and second plurality of transformation nodes; and
in response to determining that a third transformation node of the first plurality of transformation nodes depends on a fourth transformation node of the second plurality of transformation nodes subsequent to the third transformation node, moving the fourth transformation node prior to the third transformation node.

14. The system of claim 12, wherein determining the topology of the second plurality of transformation nodes comprises:
determining the topology of the second plurality of transformation nodes based on dependency of the second plurality of transformation nodes to enable at least a portion of the second plurality of transformation nodes to be executed in parallel.

15. The system of claim 9, wherein selecting the first transformation node and second transformation node comprises:
in response to determining that the first transformation node has a minimum output data size or the second transformation node has a minimum input data size among the first plurality of transformation nodes, selecting the first transformation node and second transformation node from the first plurality of transformation nodes.

16. The system of claim 9, wherein the operations further comprise:
determining an execution time of each of the first and second plurality of transformation nodes based on the input data size and parameters of the transformation node; and
determining a total execution time of the optimized machine learning pipeline based on the execution time of each of the first and second plurality of transformation nodes.

17. A computer program product comprising a computer readable storage medium having program instructions embodied therewith, the program instructions executable by a processor to cause the processor to perform operations, the operations comprising:
identifying a first plurality of transformation nodes from a machine learning pipeline;
coupling the first plurality of transformation nodes in series to obtain a sequence of transformation nodes;
in response to determining that an output data size of a first transformation node of the first plurality of transformation nodes is below a predefined threshold or an input data size of a second transformation node of the first plurality of transformation nodes is below a predefined threshold, selecting a first transformation node and a second transformation node from the sequence of transformation nodes, the second transformation node being subsequent and adjacent to the first transformation node in the sequence of transformation nodes; and
obtaining an optimized machine learning pipeline by coupling a second plurality of transformation nodes from the machine learning pipeline between the first transformation node and the second transformation node in the sequence of transformation nodes.

18. The computer program product of claim 17, wherein each of the first plurality of transformation nodes is a record operation node configured to perform a record operation on input data to the record operation node, and wherein each of the second plurality of transformation nodes is a field operation node configured to perform a field operation on input data to the field operation node.

19. The computer program product of claim 17, wherein coupling the second plurality of transformation nodes between the first transformation node and the second transformation node comprises:
determining a topology of the second plurality of transformation nodes based on input and output fields of the second plurality of transformation nodes, the topology of the second plurality of transformation nodes comprising an input and an output;
coupling the second plurality of transformation nodes to one another based on the topology of the second plurality of transformation nodes; and
coupling the input and output of the topology to the first transformation node and second transformation node, respectively.

20. The computer program product of claim 17, wherein determining the topology of the second plurality of transformation nodes comprises:
determining the topology of the second plurality of transformation nodes based on dependency of the second plurality of transformation nodes to enable at least a portion of the second plurality of transformation nodes to be executed in parallel.
